(19) United States
(12) Patent Application Publication
(10) Pub. No.: US 2014/0282163 A1
(43) Pub. Date: Sep. 18, 2014

(54) Tree Map

(71) Applicants: Jock Douglas MacKinlay, Bellevue, WA (US); Christopher Stolte, Seattle, WA (US); Maureen Stone, Woodinville, WA (US); Dirk Karis, Seattle, WA (US)

(72) Inventors: Jock Douglas MacKinlay, Bellevue, WA (US); Christopher Stolte, Seattle, WA (US); Maureen Stone, Woodinville, WA (US); Dirk Karis, Seattle, WA (US)

(21) Appl. No.: 13/844,213

(22) Filed: Mar. 15, 2013

(51) Int. Cl. G06F 3/0484

(52) U.S. Cl. CPC G06F 3/0484
USPC 715/769; 715/771

(57) ABSTRACT

A method for visualizing data is disclosed. The method is performed on a client system. The client system displays a visual representation of a set of data having a plurality of fields; wherein the visual representation is an area-based visual representation. The client system displays the plurality of fields associated with the set of data. The client system then receives an indication from a user associating a first field in the plurality of fields with a column or row attribute of the visual representation and in response to receiving the indication associating a first field in the plurality of fields with a column or row attribute of the visual representation alters the displayed representation to display the set of data as a plurality of smaller area-based visual representations which are sorted in columns or rows according to the values of the selected first field.

### TECHNICAL FIELD

The disclosed implementations relate to the field of data visualization generally and in particular to providing user accessibility features for data visualization.

### BACKGROUND

Gathering data, analyzing that data, and making decisions based on that analysis is crucial to the effective organization and management of any large scale enterprise. Corporations, governments, and non-profits all benefit from having key information available in a format that is useful for analysis. Over the last few decades, the amount of data that can be recorded and stored has increased dramatically.

With orders of magnitude more data being recorded now than at any other time in history, it is difficult to analyze all of the information available. One tool for dealing with large amounts of data is visual representations. Visual representations allow an arbitrarily large amount of data to be displayed in a format in which the information is much easier to understand and in which patterns and relationships are clearer. Visual representations can range from simple charts and graphs all the way to very complex info graphics. Effective visual representations allow users to absorb large amounts of data and quickly to find underlying connections in the data to make effective decisions.

Visual representations can be made by hand, performing the necessary calculations and converting the data into the appropriate visual format. Computer technology has allowed visual representations to be rendered quickly and automatically. The more quickly that information can be rendered into a visual representation and then re-rendered again, the more useful it is to complex analysis.

### SUMMARY

In accordance with some implementations, a method for visualizing data is disclosed. The method is performed on a client system having one or more processors and memory storing one or more programs for execution by the one or more processors. The client system displays a visual representation of a set of data having a plurality of fields; wherein the visual representation is an area-based visual representation. The client system displays the plurality of fields associated with the set of data. The client system then receives an indication from a user associating a first field in the plurality of fields with a column or row attribute of the visual representation. In response to receiving the indication associating a first field in the plurality of fields with a column or row attribute of the visual representation, the client system alters the displayed representation to display the set of data as a plurality of smaller area-based visual representations that are sorted in columns or rows according to the values of the selected first field.

In accordance with some implementations, a client system for visualizing data is disclosed. The client system has one or more processors, and memory storing one or more programs to be executed by the one or more processors. The one or more programs include instructions for displaying a visual representation of a set of data having a plurality of fields; wherein the visual representation is an area-based visual representation. The one or more programs further include instructions for displaying the plurality of fields associated with the set of data. The one or more programs further include instructions for receiving an indication from a user associating a first field in the plurality of fields with a column or row attribute of the visual representation. The one or more programs further include instructions for in response to receiving the indication associating a first field in the plurality of fields with a column or row attribute of the visual representation, altering the displayed representation to display the set of data as a plurality of smaller area-based visual representations that sorted in columns or rows according to the values of the selected first field.

In accordance with some implementations, a non-transitory computer readable storage medium storing one or more programs configured for execution by a client system is disclosed. The one or more programs also include instructions for displaying a visual representation of a set of data having a plurality of fields; wherein the visual representation is an area-based visual representation. The one or more programs further include instructions for displaying the plurality of fields associated with the set of data. The one or more programs further include instructions for receiving an indication from a user associating a first field in the plurality of fields with a column or row attribute of the visual representation. The one or more programs further include instructions for in response to receiving the indication associating a first field in the plurality of fields with a column or row attribute of the visual representation, altering the displayed representation to display the set of data as a plurality of smaller area-based visual representations that are sorted in columns or rows according to the values of the selected first field.

### BRIEF DESCRIPTION OF THE DRAWINGS

FIG. 1 is a block diagram illustrating a client-server environment in accordance with some implementations.

FIG. 2 is a block diagram illustrating a client system in accordance with some implementations.

FIG. 3 is a block diagram illustrating a server system in accordance with some implementations.

FIG. 4 depicts an exemplary user interface in accordance with some implementations.

FIG. 5 depicts an exemplary user interface in accordance with some implementations.

FIG. 6 depicts an exemplary user interface in accordance with some implementations.

FIG. 7 is a flow diagram illustrating a process for visualizing data in accordance with some implementations.

FIG. 8 is a flow diagram illustrating a process for visualizing data in accordance with some implementations.

FIG. 9 depicts an exemplary user interface in accordance with some implementations.

FIG. 10 depicts an exemplary user interface in accordance with some implementations.

FIG. 11 depicts an exemplary user interface in accordance with some implementations.

FIG. 12 depicts an exemplary user interface in accordance with some implementations.

FIG. 13 depicts an exemplary user interface in accordance with some implementations.

FIG. 14 depicts an exemplary user interface in accordance with some implementations.

FIG. 15 depicts an exemplary user interface in accordance with some implementations.

FIG. 16 is a flow diagram.

Like reference numerals refer to corresponding parts throughout the drawings.

### DESCRIPTION OF IMPLEMENTATIONS

In some implementations, a client system receives a set of data. The set of data includes a plurality of fields. For example, a set of city data includes the following fields: name of a city, population, GPS co-ordinates of the city, gender makeup of the city's population, and population density. In some implementations, the client system stores all the data in the set of data locally. In other implementations, the data is stored at a server system located remote from the client system. In other implementations, various portions of the data are stored either locally or at a server system located remotely from the client system.

In some implementations, a user of the client system requests that the data be presented in a specific visual representation. For example, the user requests to display the word frequency of one million twitter posts in a word cloud. In response to the user requests, the client system makes the calculations necessary to prepare a visual representation. In some implementations, the calculations are performed at the client system itself. In some implementations, based on available bandwidth, processing power, and storage, the calculations can be made at the server system and then transmitted to the client system for display.

In some implementations, the data received by the client system has been partially or totally rendered into the requested visual representation. For example, a client system requests a set of data from a remote server and the request includes an indication of the desired visual representation. The remote server system performs the calculations necessary to present the data set in the requested visual representation and transmits the data in a pre-rendered and ready for display format. In some implementations, the server system determines the bandwidth and processing power of both the client and server system and the connection between them and based on that determination, assigns either the server system or the client system to perform the rendering step. For example, if the server system determines that the client system has limited processing capabilities it mat assign all the rendering calculations to be performed at the server system before the data is sent to the client.

In some implementations, the client system displays a visual representation of the data set based on the calculations made by either the client system or the server system. In some implementations, the visual representation has one or more attributes. The user associated with the client system associates one or more of the data set fields to the one or more attributes of the visual representation. For example, a pie graph has two main attributes: the size of the pieces of the “pie” relative to the whole pie, and the color of the slices. A pie graph of federal spending would have several slices representing the categories of the budget and a color identifying which piece represented which category. So if the budget were 20% defense spending, 35% Medicare and Medicaid, 30% social security, and 15% discretionary spending, the resulting pie chart would assign a color to each category and visually divide the pie into 4 pieces whose size represent the percentage of the whole budget that is allocated to that category.

In some implementations, the client system displays an area-based visual representation of the data set. Examples of an area-based visual representation are tree maps and bubble maps. A tree map is a visual representation that allocates space in a visual representation based on the percentage of a total. For example, a tree map is displayed that represents 1000 students at Stanford and is sorted by state of birth. California is the state of birth for 350 of the students. The tree map would then have a size equal to 35% (350 California Students/1000 Total Students) of the total area of the visual representation. In some implementations, a tree map has at least 3 attributes: size, color, and label. So, in the above example, the number of students for each state would be assigned to the size attribute (the more students from a particular state, the large the area representing that state) and the name of the state field would be assigned to the label attribute. The color attribute could be left unassigned or assigned to a field such as average GPA or SAT score.

In some implementations, the client system displays a bubble map. A bubble map has at least three attributes as well: size of each bubble, color of each bubble, and the label on each bubble. In some implementations, the color can be unassigned. A bubble map is displayed such that all the bubbles are present on the display, but not all of the displayed space is used for bubbles. For example, data representing a country's largest exports by dollar amount would display one bubble for each export, the size of the bubble determined by the dollar amount of each exported good. Bubble maps can be used to represent handle non-additive measures like AVG(Sales) because bubble maps do not visually form a whole-part. Treemaps, on the other hand, cannot handle non-additive measures because they do form a visually whole part.

In some implementations, the client system displays a list of the fields associated with the data set. For example, a list of fields is displayed on the display proximate to the visual representation of the data set. In some implementations, the fields that are currently associated with one or more attributes of the visual representation are visually distinguished from the fields that are not currently associated with any attributes of the visual representation.

In some implementations, the entire data set is displayed as one large area based visual representation. In some implementations, the client system receives input from the user, selecting a field associated with the dataset. In some implementations, the input is received by detecting user selection of a display field in the list of displayed fields. In some implementations, the client system detects user input associating the selected field with either the row attribute or the column attribute of the visual representation.

In some implementations, in response to detecting user input associating the selected field with the row attribute, the client system alters the visual representation to display a plurality of small area-based visual representations. In some implementations, the attribute associations of the plurality of smaller area-based visual representations are the same as existed for the single, larger area-based visual representation. In some implementations, the user selects two fields, one for the row attribute and one for the column attribute. In some implementations, if only the row attribute is assigned, the smaller visual representations are displayed vertically based the value of the selected field. If only the column attribute is assigned, the smaller visual representations are displayed horizontally based upon the value of the selected field. If both are assigned, then the smaller visual representations are displayed both horizontally and vertically, based on the respectively assigned fields. For example, a tree map is displayed representing the student body of Stanford. The data is arranged by state of origin of the students, the size of the area for each state is determined by the number of students from that state, and the color of the state is determined by average current GPA. The user selects the class year field and drags it to the row attribute. In response, the client system now displays four smaller tree maps (one for each of freshman, sophomore, Junior, and Senior class year). However, the other properties of the visual representation are unchanged. The data is still arranged by state of origin, the size is still determined by the number of students, and the associated color still correlates to average current GPA of the students from the state.

In some implementations, the client system also displays attribute icons related to the attributes of the displayed representation of the data set. In some implementations, the user can select one of the displayed fields, drag it over to one of the displayed attribute icons, and release it. The client system will then associate the selected field with the attribute associated with the attribute icon over which the selected field was released. For example, a tree map is displayed and has size associated with number of students, color associated with average GPA, label associated with state name, and attribute icons corresponding to the size, color, and label attributes. The user selects average amount of student aid and drags it over the color attribute icon. In response, the client system changes the colors of the various areas to correlate to the average amount of student aid given to students from the associated state.

In some implementations, some attributes allow more than one field to be associated with it at a time. Thus, dragging a selected field over the attribute icon results in adding another field to the associated attributes, and not removing any. For example, the label attribute can include multiple fields. In some implementations, the label attribute is associated with the text displayed on a sub area of the visual representation. In some implementations, a user can customize the display attributes of the label text including, but not limited to: size, location, font, color, and relative position.

In some implementations, attributes with multiple fields associated also track the nesting order of those attributes. The appearance of the attribute is determined based on the nested ordering of the fields. For example, if a label attribute has both a state name field and an average income field associated with it, layout of those two fields is determined by the nesting order. In some implementations, the first listed field will be displayed above to be second listed field.

In some implementations, two fields have a hierarchical relationship when one functionally depends on the other. For example, every state could be assigned to a market, which means the market field functionally depends on the state field. In a treemap with market first in the sort order, the states for a given market will form a rectangle for that market. Each market rectangle will have a thicker border and a title associated with it. Each market rectangle will be divided into smaller sections based on each state. In some implementations, users may nest fields that do not form hierarchies and to have hierarchical fields in nest orders that do not match the hierarchy. That is, nesting is a more general concept that works for hierarchical fields. In some implementations, hierarchical data can also be stored in two tables: node and edge.

FIG. 1 is a block diagram illustrating a client-server environment 100, in accordance with some implementations. The client-server environment 100 includes one or more client systems 102, a server system 130, and a network 120. In some implementations, a client system 102-1 includes a web browser application 104-1, a display 106-1, a data cache 108-1, a visual data rendering module 110-1, and a user input analysis module 112-1. In some implementations, the client system 102-1 is an all-in-one desktop computer system, a laptop or tablet computer, a smart phone, or a handheld gaming system. In some implementations, the display 106-1 is any device associated with the client system 102-1 capable of displaying visual information, including a computer monitor, a projector, a display integrated into a smart phone or a tablet, or any other display device. The network 120 may be any of a variety of networks, including local area networks (LAN), wide area networks (WAN), wireless networks, wired networks, the Internet, or a combination of such networks.

In some implementations, the data cache 108-1 includes data retrieved from the server system 130 and stored for later use. In some implementations, the data cache 108-1 includes pre-rendered images, calculated visual data, and raw data received from the server system 130. In some implementations, the server system 130 transmits data to be cached in the data cache 108-1 based on the data that the server anticipates the client server 102-1 will need in the near future. When the client system 102-1 determines a need for an updated displayed visual representation, the client system 102-1 first determines whether the data or image necessary to update the displayed visual representation is stored in the data cache 108-1. In accordance with a determination that the necessary data is available in the data cache 108-1, the client system 102-1 renders the necessary updated visual representation. Otherwise, the client system 102-1 requests the necessary information (data or images) from the server system 130.

In some implementations, the visual data rendering module 110-1 is a software module distinct from the web-browser 104-1. The visual data rendering module 110-1 receives data from the server system 130 when the server system determines, based on the capabilities of the server system 130, the property of the data sets and the requested type of visualization. In some implementations, the server system 130 transmits visual data 126 to the client system 102-1, wherein the visual data includes pre-calculated information needed to correctly render the requested visual representation. In other implementations, the server system transmits the entire set of raw data to the visual data rendering module 110-1, and the client system performs all necessary calculations and renders the required images.

In some implementations, the user input analysis module 112-1 is a software module distinct from the web-browser 104-1. The user input analysis module 112-1 receives or detects user input. In some implementations, the received user input is transmitted to a server system 130 for analysis. In other implementations, the user input analysis module 112-1 analyzes user input and responds accordingly. In some implementations, the user selects a field associated with the currently displayed set of data and associates it with a column or row attribute associated with the current visual representation. In response, the user input analysis module 112-1 determines that the user input results in a change in the visual representation.

In some implementations, the user input analysis module 112-1 then instructs the visual data rendering module 110-1 or the data rendering module 140 at the server system 130 to alter the current visualization to display several smaller visualizations in an order determined by the field now associated with the row or column attribute of the visual representation. For example, if the user selects student gender and associates it with the column attribute, the large area-based visual representation will be redisplayed into two smaller area-based representations, one associated with students whose gender is listed as male and one associated with students whose gender is listed as female. The two visual representations will be displayed in two separate rows.

In some implementations, the user input analysis module 112-1 determines that the user has selected a field in the plurality of fields associated with the data set, dragged the selected field to a plurality of displayed attribute icons, and ceased selection of the selected field proximate to one of the attribute icons. Each attribute icon is associated with a particular attribute of the visual representation. For example, if the visual representation has size, color, and label attributes, there would be an attribute icon associated with each of the attributes. In some implementations, the user input analysis module 112-1 determines which attribute icon in the plurality of attribute icons was closest to the point at which the selected field was released. In response, the user input analysis module 112-1 instructions the data calculation module at the server system 130 to recalculate the values needed for the visual representation replacing the old field associated with the selected attribute with the new selected field.

In some implementations, a client system 102-2 includes a web-browser 104-2, a display 106-2, and data cache 108-2. In some implementations a web-browser 104-2 includes a visual data rendering module 110-2. When the web browser 104-2 includes a visual data rendering module 110-2, the web browser does not need a plug-in or stand alone application to render visual representations of data. For example, the newest versions of Internet Explorer, Chrome, Firefox, and other modern browsers implement the HTML5 standard and thus are able to render visual representations of data.

In some implementations, the client system 102-3 includes a web-browser 104-3 and a display 106-3. The web-browser 104-3 does not include the ability to render visual data at the client system 102-3. The client system 103-2 is then only able to receive pre-rendered images 124 from the server system 130. However the client system 102-3 does not render images or perform any calculations to prepare data for being visually displayed.

In some implementations, the web browser 104 sends data requests 122 from the client systems 102 to the server system 130. The data request 122 includes the data requested, the type of visual representation requested, and the capabilities of the client system 102.

In some implementations, the sever system 130 includes a stored data database 132, a communication module 134, a user command analysis module 136, a data calculation module 138, and a data rendering module 140. The stored data database 132 includes all of the data contained in the server system 130. In some implementations, the data stored in the stored data database 132 is added by the administrators of the server system 130. In other implementations, users are able to add or modify data stored in the stored data database 132.

In some implementations, the server system 130 includes a communication module 134. The communication module 134 receives communications from one or more client systems 102 over the network 120. Specifically, the communication module 134 receives data requests 122 from client systems 102. The data requests 122 include a request to display a visual representation of a specific data set, the specific type of visual representation requested, and capabilities of the client system 102. The communication module 134 requests the appropriate data set from the stored data database 132. For example, if the data request 122 requests all 60 million airline flights in the US, the stored data database 132 gathers the appropriate data and transfers it to the data calculation module 128. The communication module 134 further passes the type of visual representation and the capabilities of the client system to the data calculation module 138.

In some implementations, the user command analysis module 136 receives user commands from the data requests 122 sent from the client system 102 and passed through the communication module 134. In some implementations, the user command analysis module 136 determines what the user request is and how best to respond to that request. In some implementations, the user command analysis module 136 determines that the user is requesting a change to the visual representation currently being displayed. In some implementations, a single area-based visual representation is current displayed at a client system. The user command analysis module 136 receives a user command to associate a data field of the currently displayed data set with either the row or column attribute of the visual representations.

In some implementations, in response to this request, the user command analysis module 136 determines which field the user wishes to associate and with which attribute the user wishes to associate it. In some implementations, user command analysis module 136 determines that the user wishes to associate a particular field with the row attribute. In some implementations, in response user command analysis module 136 instructs the data calculation module 138 to calculate data to display several smaller visual representations of the data set vertically, ordered in accordance with the selected field. Similarly, when the user command analysis module 136 determines the user wishes to associate a particular field with the column attribute, the user command analysis module 136 instructs the data calculation module 138 to calculate data to display several smaller visual representations of the data set horizontally, ordered in accordance with the selected field.

In some implementations, the user command analysis module 136 determines that the user has selected a field to associate with an attribute of the currently displayed visual representation that is already associated with another field. In response, the user command analysis module 136 instructs the data calculation module 138 to re-calculate the data necessary for displaying the visual representation with the newly selected field associated with the selected attribute.

In some implementations, the data calculation module 138 receives the requested data set and the requested type visual representation from the user command analysis module 136. The data calculation module 138 uses raw data to calculate the visual data needed to render an image for the requested type of visual representation. For example, if the user requested the data to be presented in the form of a bar graph, the data calculation module 138 would calculate the dimensions of the graph and the height of the rows. Once the visual data 126 has been calculated, it is transmitted to either the data rendering module 140 or the client system 102, depending on where the server system 130 has allocated the work associated with rendering the visual representation.

In some implementations, the data rendering module 140 receives calculated visual data 126 from the data calculation module 138. The data rendering module 140 uses the calculated data 126 to produce a visual image, representing the requested data set in the requested visual presentation style. The generated image 124 is then transmitted to the client system 102 for display.

FIG. 2 is a block diagram illustrating a client system 102, in accordance with some implementations. The client system 102 typically includes one or more processing units (CPUs) 202, one or more network interfaces 210, memory 212, and one or more communication buses 214 for interconnecting these components. The client system 102 includes a user interface 204. The user interface 204 includes an associated display device 106 and optionally includes an input means such as a keyboard, mouse, a touch sensitive display, or other input buttons 208. Optionally, the display device 106 includes an audio device or other information delivery device. Furthermore, some client systems use a microphone and voice recognition to supplement or replace the keyboard.

Memory 212 includes high-speed random access memory, such as DRAM, SRAM, DDR RAM, or other random access solid state memory devices; and may include non-volatile memory, such as one or more magnetic disk storage devices, optical disk storage devices, flash memory devices, or other non-volatile solid state storage devices. Memory 212 may optionally include one or more storage devices remotely located from the CPU(s) 202. Memory 212, or alternately the non-volatile memory device(s) within memory 212, includes a non-transitory computer readable storage medium. In some implementations, memory 212 or the computer readable storage medium of memory 212 stores the following programs, modules and data structures, or a subset thereof:
an operating system 216 that includes procedures for handling various basic system services and for performing hardware dependent tasks;
a network communication module 218 that is used for connecting the client system 102 to other computers via the one or more communication network interfaces 210 (wired or wireless) and one or more communication networks, such as the Internet, other wide area networks, local area networks, metropolitan area networks, and so on;
a display module 220 for enabling presentation of media content on a display 106 associated with the client system 202;
one or more client system 202 applications module(s) 222 for enabling the client system 202 to perform the functions offered by the client system 202, including but not limited to:
   a web browser 104 for requesting, receiving, and displaying information over the network (FIG. 1, 120)
   a visual data rendering module 110 for using received visual data (FIG. 1, 126) to create an image based on the requested visual representation; and
   a user input analysis module 112 for receiving user commands that associate fields with attributes of a visual representation, receiving user requests to change the appearance a visual representation, and in response to those requests, causing the visual representation to be updated.
a data module 224 for storing data related to the client system 102, including but not limited to:
   cached data 108, including data received from the server system (FIG. 1, 130) and stored on the client system 102 for future use.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various embodiments. In some embodiments, memory 212 may store a subset of the modules and data structures identified above. Furthermore, memory 212 may store additional modules or data structures not described above.

Although FIG. 2 shows a client device 102, FIG. 2 is intended more as functional description of the various features that may be present rather than as a structural schematic of the embodiments described herein. In practice, and as recognized by those of ordinary skill in the art, items shown separately could be combined and some items could be separated.

FIG. 3 is a block diagram illustrating a server system 130, in accordance with some implementations. The server system 130 typically includes one or more processing units (CPUs) 302, one or more network interfaces 304, memory 306, and one or more communication buses 308 for interconnecting these components.

Memory 306 includes high-speed random access memory, such as DRAM, SRAM, DDR RAM, or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the CPU(s) 302. Memory 306, or alternately the non-volatile memory device(s) within memory 306, includes a non-transitory computer readable storage medium. In some implementations, memory 306 or the computer readable storage medium of memory 306 stores the following programs, modules, and data structures, or a subset thereof:
an operating system 310 that includes procedures for handling various basic system services and for performing hardware dependent tasks;
a network communication module 134 that is used for connecting the server system 130 to other computers via the one or more communication network interfaces 308 (wired or wireless) and one or more communication networks, such as the Internet, other wide area networks, local area networks, metropolitan area networks, and so on;
one or more server application module(s) 314 for enabling the server system 130 to perform the functions offered by the server system 130, including but not limited to:
   a user command analysis module 136 for receiving user commands that associate fields with attributes of a visual representation, receiving user requests to change the appearance a visual representation, and in response to those requests, causing the visual representation to be updated;
   a data calculation module 138 for calculating the data necessary to create a visual representation of the requested data in the requested representation style; and
   a data rendering module 140 for using the calculated data 126 to produce a visual image, representing the requested data set in the requested visual presentation style;
one or more server data module(s) 316 for storing data related to the server system 130, including but not limited to:
   stored data database 132 including all of the raw data stored at the server system that users may request to view in a visual representation.

FIG. 4 depicts an exemplary user interface in accordance with some implementations. In this example, the user interface 400 includes a title 402 and a list of attributes 404-1 and 404-2. In some implementations, the attributes are represented as attribute icons, over which fields can be dropped. The user interface 400 also includes a list of data fields 406 associated with the data set. Each field is listed (408-1-408-9), and in some implementations, each field is selectable.

In some implementations, fields that are currently selected for use in the visualization are visually distinguished as such. In this example, 408-3 (the Home State field) is visually distinctive as being used in the current visual representation.

This example also includes an area-based visual representation of the data set 420, in this case a tree map. The area for the visual representation is divided into a series of sub-areas 422. Each sub-area has a size and a label 424, wherein the label identifies the state which it corresponds and the size represents the number of students from that state. If the name of the state is too large to fit in the sub-area to which it corresponds, the name may be shown in abbreviated form (Tenn. for Tennessee, for example), in its official two letter abbreviation (KY for Kentucky, for example), or not displayed at all.

FIG. 5 depicts an exemplary user interface in accordance with some implementations. In this example, the user interface 500 includes a title 502 and a list of attributes 504-1 and 504-2. In some implementations, the attributes are represented as attribute icons, over which fields can be dropped. In this example, a data field 526 has been associated with the row attribute and has been displayed proximate to the row attribute label. The user interface 500 also includes a list of data fields 506 associated with the data set. Each field is listed (508-1-508-9), and, in some implementations, each field is selectable.

In some implementations, fields that are currently selected for use in the visualization are visually distinguished as such. In this example, 508-3 (the Home State field) and 508-5 are visually distinctive as being used in the current visual representation.

This example also includes an area-based visual representation of the data set 520, in this case two smaller tree maps, ordered by the data field associated with the row attribute (in this case the gender 508-5 data field). Each row (528-1 and 528-2) includes a label and a corresponding tree map 522-1 and 522-2. The area for the visual representation is divided into a series of sub-areas 522. Each sub-area has a size and a label 524, wherein the label identifies the state to which it corresponds and the size represents the number of students from that state. As noted above, if the name of the state is too large to fit in the sub-area to which it corresponds, the name may be shown in abbreviated form (Tenn. for Tennessee, for example), in its official two letter abbreviation (KY for Kentucky, for example), or not displayed at all.

FIG. 6 depicts an exemplary user interface in accordance with some implementations. In this example, the user interface 600 includes a title 602 and a list of attributes 604-1 and 604-2. In some implementations, the attributes are represented as attribute icons, over which fields can be dropped. In this example, a first data field 626-1 (Gender) has been associated with the row attribute and has been displayed proximate to the row attribute label 604-1 and a second data field 626-2 (Class year) has been associated with the column attribute and has been displayed proximate to the column attribute label 604-2. The user interface 600 also includes a list of data fields 606 associated with the data set. Each field is listed (608-1-608-9), and, in some implementations, each field is selectable.

In some implementations, fields that are currently selected for use in the visualization are visually distinguished as such. In this example, 608-3 (the Home State field), 608-5 (Gender), and 608-7 (Class Year) are visually distinctive as being associated with attributes in the current visual representation.

This example also includes an area-based visual representation of the data set 620, in this case eight smaller tree maps, ordered vertically by the data field associated with the row attribute (in this case the gender 608-5 data field) and ordered horizontally by the data field associated with the column attribute (in this case the class year 508-7 data field). Each row (628-1 and 628-2) includes label and a four corresponding tree maps for each row ordered by class year (Freshman-Senior). These smaller tree maps 630-1-632-4 and 632-1-632-4 allow gender and class years to be compared. The area for the visual representation is divided into a series of sub-areas. Each sub-area has a size and a label 624, wherein the label identifying the state to which it corresponds and the size represents the number of students from that state. As noted above, if the name of the state is too large to fit in the sub-area to which it corresponds, the name may be shown in abbreviated form (Tenn. for Tennessee, for example), in its official two letter abbreviation (KY for Kentucky, for example), or not displayed at all.

FIG. 7 is a flow diagram illustrating a process for visualizing data in accordance with some implementations. Each of the operations shown in FIG. 7 may correspond to instructions stored in a computer memory or computer readable storage medium. Optional operations are indicated by dashed lines (e.g., boxes with dashed-line borders). In some implementations, the method described in FIG. 7 is performed by a client system (FIG. 1, 102).

In accordance with some implementations, the client system (FIG. 1, 102) displays a visual representation of a set of data having a plurality of fields, wherein the visual representation is an area-based visual representation (702). In some implementations, the area-based visual representation is a tree map. In some implementations, the area-based visual representation is a bubble map. In some implementation, the visual representation of a data set is a single large visualization.

In some implementations, the client system (FIG. 1, 102) displays a plurality of fields associated with the set of data (704). In some implementations, a field describes a particular aspect of a data record. For example, in a plurality of data records for students, fields might include gender, address, home state, GPA, class year, and total credits. In some implementations, the plurality of fields is displayed simultaneously with the visual representation. In some implementations, the plurality of fields is displayed as a result of a user selecting a “display fields” option.

In some implementations, the client system (FIG. 1, 102) receives an indication from a user associating a first field in the plurality of fields with a first attribute of the visual representation (706). In some implementations, the first attribute is a row or column attribute. In some implementations, the user selects a field from the displayed list of fields, drags the selected field, and drops the selected field proximate to or on an attribute icon associated with the row or column attribute of the visual representation.

In some implementations, the visual representation is divided into a plurality of sub-areas based on a second field of the plurality of fields. For example, a visual representation that represents population by state would have a sub-area for each state included in the visual representation. In some implementations, the pluralities of sub-areas have a first attribute associated with a third field in the plurality of fields and a second attribute associated with a fourth field in the plurality of fields.

In some implementations, the client system (FIG. 1, 102), in response to receiving the indication associating a first field in the plurality of fields with a column or row attribute of the visual representation, alters the displayed representation (708). In some implementations, altering the displayed representation includes displaying the set of data as a plurality of smaller area-based visual representations that are sorted in columns or rows according to the values of the selected first field. For example, if, while displaying a tree map of population by state, the user selects geographic region and associates it with the row attribute, the visual representation would change to display six smaller tree maps vertically, one for each geographic region. (South, Northeast, Atlantic, Midwest, Intermountain West, and West). In some implementations, each smaller visual representation in the plurality of smaller visual representations includes is divided into a plurality of sub-areas based on a second field of the plurality of fields.

In some implementations, more than one field is associated with the first attribute and the fields associated with first attribute are arranged in a first order. In some implementations, the appearance of the visual representation is associated with the ordering of the fields. The indication received from the user includes instructions to change the order of the fields associated with the first attribute from the first order to a second order distinct from the first order. In some implementations, altering the displayed representation includes changing the nested ordering of the visual representation to match the second order of the fields associated with the first attribute.

In some implementations, the client system (FIG. 1, 102) detects user selection of a fifth field in the plurality of displayed fields and assignment of the field of the set of data to a row or column attribute of the visual representation (710). In some implementations, the client system (FIG. 1, 102) responds to user selection of a fifth field by displaying the set of data as a plurality of smaller visual representations that are sorted in rows and columns according to the values of the selected fifth field and the selected first field, wherein each respective smaller visual representation in the plurality of visual representations is divided into a plurality of sub-areas based on a second field of the set of data and has a first attribute that is associated with the third field in the plurality of fields and a second attribute that is associated with the fourth field in the plurality of fields (712).

FIG. 8 is a flow diagram illustrating a process for visualizing data in accordance with some implementations. Each of the operations shown in FIG. 8 may correspond to instructions stored in a computer memory or computer readable storage medium. Optional operations are indicated by dashed lines (e.g., boxes with dashed-line borders). In some implementations, the method described in FIG. 8 is performed by a client system (FIG. 1, 102).

In some implementations, the client system (FIG. 1, 102) detects user selection of a sixth field in the plurality of displayed fields and assignment of the field of the set of data to a label attribute of the visual representation (802). In some implementations, the label attribute of a visual representation is the data that is displayed on a sub-area associated with a particular record. In other implementations, the label attribute is used to create a legend that explains the data presented in the visual representation.

In some implementations, the client system (FIG. 1, 102) displays the text associated with the selected sixth field on each sub-area of the plurality of sub-areas (804). For example, when displaying a tree map of the population of the United States by state, the use could select “State Name” and associate it with the label attribute. In response, each sub-area would display the state name with which it was associated on the sub-area.

In some implementations, the client system (FIG. 1, 102) receives a request from a user to customize the appearance attributes of the text displayed on each sub-area (806) as a label. In response to receiving a request to customize appearance attributes of the label attribute, the client system (FIG. 1, 102) changes the appearance of the text displayed on each sub-area. For example, if each sub-area in a visual representation includes the name of the associated state and the two-letter abbreviation for that state, the user could issue a request to alter the size, font, or order of that text. The client system would display the text as requested.

FIG. 9 depicts an exemplary user interface in accordance with some implementations. In this example, the user interface 900 includes a title 902 and a list of attributes 904-1 and 904-2. In some implementations, the attributes are represented as attribute icons, over which fields can be dropped. In this example, data fields 910-1 (Market) and 910-2 (State) have been associated with the row attribute and has been displayed proximate to the row attribute label. The fields are displayed in the nesting order. Thus, changing the order in which the fields are displayed will change the displayed visual information. Data field 910-3 (sales) has been associated with the column attribute and has been displayed proximate The user interface 900 also includes a list of data fields 906 associated with the data set. Each field is listed (908-1-908-3), and, in some implementations, each field is selectable.

This example also includes an bar chart visual representation of the data set, displayed with sales data wherein each row is sorted by market data 912-1 first, because the market field 910-1 is first in the row nesting order, and the sorted by state name 912-2 because the state field 910-2 is listed second in the row nesting order. The sales data is then represented by a bar 918, the length of the bar is determined by the amount of sales.

FIG. 10 depicts an exemplary user interface in accordance with some implementations. In this example, the user interface 1000 from FIG. 9 has been adjusted to move the state name 910-1 field ahead of the market field 910-2 in the nesting order for the row attribute. This results in a change in the displayed visualization. Although the column still represents the total sales as a bar, each row is now sorted by state name 912-1 first, and market second 912-2.

FIG. 11 depicts an exemplary user interface in accordance with some implementations. In this example, the user interface 1100 includes a title 1102 and a row attribute area 404-1 and a column attribute area 404-2. The user interface also includes an attribute icon area 1110. In some implementations, the attribute icon area 1110 includes attribute icons, over which fields can be dropped. The user interface 400 also includes a list of data fields 1106 associated with the data set. Each field is listed (1108-1-1108-9), and in some implementations, each field is selectable.

In some implementations, the attribute icon area 1110 includes a plurality of attribute icons (1112-1 to 1112-3). Each attribute icon 1112 includes a label that describes the attribute of the visual representation with which it is associated. In this example, there are three attribute icons displayed: color 1112-1, size 1112-2, and label 1112-3. In some implementations, and in this example, the attribute icon area includes a list of the fields currently associated with each attribute. The size attribute 1112-1 is associated with city population 1116-1 and the label attribute label 1112-3 is associated with state name field 1116-2. The color attribute 1114-1 is currently unassigned and thus no field name is displayed.

This example also includes an area-based visual representation of the data set, in this case a bubble map 1118. Each bubble has a size and a label, wherein the label identifies the name of the city to which it corresponds and the size represents the population of the city. If the name of the state is too large to fit in the sub-area to which it corresponds, the name may be shown in abbreviated form (Phila for Philadelphia) or not displayed at all. This example shows the 10 most populous cities in the United States of America.

In this example, a user has selected a new data field (in this case density 1108-4) with a selection mechanism of some kind Any type of input may be used to select a new data field, including but not limited to a mouse, a key board, a finger touch on a touch sensitive surface or a touch sensitive screen, an audio input device, or a stylus.

FIG. 12 depicts an exemplary user interface in accordance with some implementations. In this example, the user interface 1100 from FIG. 11 is still depicted. The user selection has moved from the data fields area 1106 to the attribute icons area 1110. In some implementations, moving the user selection tool (i.e. cursor or detected finger or stylus contact) while still continuing to select the data field (in this case density 1108-4) causes a visual depiction of the selected field to move with the user selection tool visualization or contact point. In some implementations, the visual depiction of the selected data field is a visual altered version of the displayed data field (1108-4). In some implementations, the visual depiction is grayed out or made partially or wholly transparent.

In this example, the user selection tool 1120 moves to the attribute icon area 1110 and ceases selection of the selected data field (1108-4). In some implementations, this is accomplished by releasing a key or button an input device, entering additional input on an input device, or ceasing contact with a finger or stylus on a touch sensitive surface or screen.

FIG. 13 depicts an exemplary user interface in accordance with some implementations. In this example, the user interface 1100 from FIG. 11 is still depicted. The density data field 1108-4 has been dragged to and released over the size attribute icon 1112-2 in the attribute icon area 1110. In response, the size label 1112-2 now lists density as the associated data field 1116-3.

The area-based visual representation of the data set 1118 has also been changed. The size of the various bubbles in the visual representation is determined by the populations of the cities they represent. Each bubble still has a size and a label, wherein the label identifies the name of the city to which it corresponds but the size now represents population density of the population. The list of cities represented has mostly changed because the top 10 densest cities in the United States of America are mostly different from the most populous cities (except for New York). Thus, the visual representation has been total changed merely by dragging a new data field onto one of the attribute icons.

FIG. 14 depicts an exemplary user interface in accordance with some implementations. In this example, the user interface 400 includes a title 1402 and a list of attributes 1404-1 and 1404-2. In some implementations, the attributes are represented as attribute icons, over which fields can be dropped. The user interface 1400 also includes a list of data fields 1406 associated with the data set. Each field is listed (1408-1-1408-4), and in some implementations, each field is selectable. In this example, the data set is responses to a nationwide survey asking people what term they used to refer to carbonated beverages. The data fields only include state of residence 1408-1, preferred term 1408-2, age 1408-3, and gender 1408-4.

This example also includes an area-based visual representation of the data set 420, in this case a tree map. The area for the visual representation is divided into a series of sub-areas 422 representing each state. Each state is then broken down into the number of people in that state that use each particular term. Each sub-area has a size and a label 424, wherein the label identifies the state which it corresponds and the size represents the number of total respondents. The size of the divisions within each state subarea represents the percentage of people who use the terms associated with the division. If the name of the state is too large to fit in the sub-area to which it corresponds, the name may be shown in abbreviated form (Tenn. for Tennessee, for example), in its official two letter abbreviation (KY for Kentucky, for example), or not displayed at all.

FIG. 15 depicts an exemplary user interface in accordance with some implementations. In this example, the user interface 1400 includes a title 1402 and a list of attributes 1404-1 and 1404-2. In some implementations, the attributes are represented as attribute icons, over which fields can be dropped. In this example, a data field 1506 (Preferred Term) has been associated with the row attribute and has been displayed proximate to the row attribute label. The user interface 500 also includes a list of data fields 506 associated with the data set. Each field is listed (508-1-508-4), and, in some implementations, each field is selectable.

This example also includes an area-based visual representation of the data set, in this case 5 tree maps displayed as bars, ordered by the data field associated with the row attribute (in this case the preferred term 1506 data field). Each row includes a label 1502 and a corresponding tree map 1504. The area for each bar is divided into a series of sub-areas. Each sub-area has a size and a label, wherein the label identifies the state to which it corresponds and the size represents the number of respondents from that state. As noted above, if the name of the state is too large to fit in the sub-area to which it corresponds, the name may be shown in abbreviated form (Tenn. for Tennessee, for example), in its official two letter abbreviation (KY for Kentucky, for example), or not displayed at all. By displaying the data set in bar form, it's possible to easily see which terms are the most preferred in the whole country and in what states they are the most popular.

FIG. 16 is a flow diagram illustrating a process for visualizing data in accordance with some implementations. Each of the operations shown in FIG. 16 may correspond to instructions stored in a computer memory or computer readable storage medium. Optional operations are indicated by dashed lines (e.g., boxes with dashed-line borders). In some implementations, the method described in FIG. 16 is performed by a client system (FIG. 1, 102).

In accordance with some implementations, the client system (FIG. 1, 102) displays a visual representation of a set of data, the set of data including a plurality of fields (1602). In some implementations, the client system (FIG. 1, 102) displays a list fields associated with the set of data (1604). In some implementations, the client system (FIG. 1, 102) displays one or more visual representations attribute icons; wherein each icon corresponds to an attribute of the displayed visual representation (1606).

In some implementations, the client system (FIG. 1, 102) detects a selection gesture on a first field in the displayed list of fields (1608). In some implementations, the client system (FIG. 1, 102), while detecting the selection gesture, detects a dragging gesture from the displayed list of fields to a displayed visual representation icon (1610).

In some implementations, the client system (FIG. 1, 102) ceases to detect the selection gesture (1612). In some implementations, the client system (FIG. 1, 102), in response to cessation of the selection gesture, associates the selected first field with the particular visual representation attribute icon displayed at the position on the display where the selection gesture ceased (1614) and changes the visual representation such that the attribute of the visual representation that corresponds to the particular visual representation attribute icon is now associated with the first field (1616).

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present implementations. The first contact and the second contact are both contacts, but they are not the same contact.

The terminology used in the description of the implementations herein is for the purpose of describing particular implementations only and is not intended to be limiting. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if (a stated condition or event) is detected” may be construed to mean “upon determining” or “in response to determining” or “upon detecting (the stated condition or event)” or “in response to detecting (the stated condition or event),” depending on the context.

What is claimed is:

1. A method for visualizing data, comprising:
at a client system having one or more processors and memory storing one or more programs for execution by the one or more processors:
displaying a visual representation of a set of data having a plurality of fields; wherein the visual representation is an area-based visual representation;
displaying the plurality of fields associated with the set of data;
receiving an indication from a user to associate a first field in the plurality of fields with an first attribute of the visual representation; and
in response to receiving the indication to associate a first field in the plurality of fields with a first attribute of the visual representation:
altering the displayed representation of the data set.

2. The method of claim 1, wherein the attribute of the visual representation is a row or column attribute and altering the displayed representation includes displaying the set of data a plurality of smaller area-based visual representations that are sorted in columns or rows according to the values of the selected first field.

3. The method of claim 1, wherein:
more than one field is associated with the first attribute;
the fields associated with first attribute are arranged in a first order;
the appearance of the visual representation is associated with the ordering of the fields;
the indication received from the user includes instructions to change the order of the fields associated with the first attribute from the first order to a second order distinct from the first order; and
altering the displayed representation includes changing the nested ordering of the visual representation to match the second order of the fields associated with the first attribute.

4. The method of claim 1, wherein the visual representation is divided into a plurality of sub-areas based on a second field of the plurality of fields.

5. The method of claim 2, wherein the pluralities of sub-areas have a first attribute associated with a third field in the plurality of fields and a second attribute associated with a fourth field in the plurality of fields.

6. The method of claim 2, wherein each smaller visual representation in the plurality of smaller visual representations includes is divided into a plurality of sub-areas based on a second field of the plurality of fields.

7. The method of claim 6, further including:
detecting user selection of a fifth field in the plurality of displayed fields and assigning the field of the set of data to a row or column attribute of the visual representation; and
in response to detecting assignation of the fifth field to the row attribute of the visual representation:
displaying the set of data as a plurality of smaller visual representations which are sorted in rows and columns according to the values of the selected fifth field and the selected first field, wherein each respective smaller visual representation in the plurality of visual representations is divided into a plurality of sub-areas based on a second field of the set of data and has a first attribute that is associated with the third field in the plurality of fields and a fourth attribute that is associated with the second field in the plurality of fields.

8. The method of claim 1, further including:
detecting user selection of a sixth field in the plurality of displayed fields and assigning the field of the set of data to a label attribute of the visual representation; and
displaying text associated with the sixth field on each sub-area of the plurality of sub-areas.

9. The method of claim 8, wherein more than one field is assigned to the label attribute of the visual representation.

10. The method of claim 9, further comprising:
receiving a request from a user to customize appearance attributes of the text displayed on each sub-area as a label; and
in response to receiving a request to customize appearance attributes of the label attribute, changing the appearance of the text displayed on each sub-area.

11. The method of claim 10, wherein the appearance attributes include size, color, position on the sub-area, and, if more than one field is a associated with the label attribute, the relative position of a respective field.

12. The method of claim 5, wherein the first attribute is size.

13. The method of claim 5, wherein the first attribute is color.

14. The method of claim 1, wherein the visual representation is a tree map.

15. The method of claim 1, wherein the visual representation is a bubble map.

16. An electronic device for fulfilling a recommendation request, comprising:
one or more processors and memory storing one or more programs to be executed by the one or more processors;
the one or more programs comprising instructions for:
displaying a visual representation of a set of data having a plurality of fields; wherein the visual representation is an area-based visual representation;
displaying the plurality of fields associated with the set of data;
receiving an indication from a user associating a first field in the plurality of fields with a column or row attribute of the visual representation; and
in response to receiving the indication associating a first field in the plurality of fields with a column or row attribute of the visual representation:
altering the displayed representation to display the set of data as a plurality of smaller area-based visual representations which are sorted in columns or rows according to the values of the selected first field.

17. A non-transitory computer readable storage medium storing one or more programs configured for execution by a computer, the one or more programs comprising instructions for:
displaying a visual representation of a set of data having a plurality of fields; wherein the visual representation is an area-based visual representation;
displaying the plurality of fields associated with the set of data;
receiving an indication from a user associating a first field in the plurality of fields with a column or row attribute of the visual representation; and
in response to receiving the indication associating a first field in the plurality of fields with a column or row attribute of the visual representation:
altering the displayed representation to display the set of data as a plurality of smaller area-based visual representations which are sorted in columns or rows according to the values of the selected first field.

18. A method for visualizing data, comprising:
at a client system having one or more processors and memory storing one or more programs for execution by the one or more processors:
displaying a visual representation of a set of data, the set of data including a plurality of fields;
displaying a list fields associated with the set of data;
displaying one or more visual representations attribute icons; wherein each icon corresponds to an attribute of the displayed visual representation;
detecting a selection gesture on a first field in the displayed list of fields;
while detecting the selection gesture, detecting a dragging gesture from the displayed list of fields to a displayed visual representation icon;
ceasing to detect the selection gesture;
in response to cessation of the selection gesture:
associating the selected first field with the particular visual representation attribute icon displayed at the position on the display where the selection gesture ceased; and
changing the visual representation such that the attribute of the visual representation that corresponds to the particular visual representation attribute icon is now associated with the first field.
